(19) United States
(12) Patent Application Publication
(10) Pub. No.: US 2005/0257342 A1
(43) Pub. Date: Nov. 24, 2005

(54) Decorative doorstops/usable art

(76) Inventor: Cynthia Jean Cohen, Winter Park, FL (US)

Correspondence Address: Cynthia Jean Cohen, 483 Lakewood Drive, Winter Park, FL, 32789, US

(21) Appl. No.: 10/774,942

(22) Filed: May 18, 2004

(51) Int. Cl. E05F 5/02

(52) U.S. Cl. 16/82

(57) ABSTRACT

The Decorative Doorstop is unique in the variety of very decorative coverings and ornamentations utilized to encase the weighted bag of sand that provides the bulk to allow the doorstop to function as it is placed adjacent to the doors that are to be held open. Also, the very decorative variety of designs allows it to be utilized as stand alone art or incorporated into any variety of decorative schemes for a desired room or enclosure.

Making these doorstops unique is the very decorative coverings utilized to encase the weighted bag of sand. The doorstops function by placing them on the floor adjacent to the door to be held open. In addition, secondary to their very decorative design, the doorstops can be utilized as stand alone art or incorporated into any variety of decorative schemes for any desired room.

### CONSTRUCTION OF DOOR STOPS

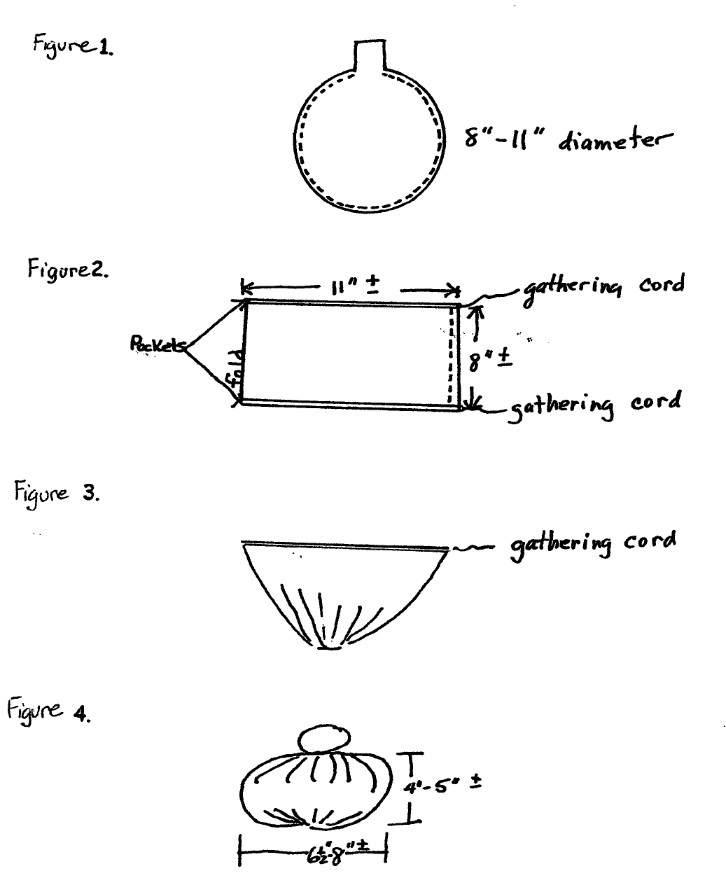

Step 1. Sew together two round pieces of fabric (approximate diameter to range between 8″ and 11′) to create a circle with small opening and flange to permit filling with sand or other like material—fill and then close opening with thread, hot glue or other means to secure the contents. See FIG. 1 on Page 3.

Step 2. Sew together a piece of fabric or fabrics that has pockets on the longest edges to accommodate a cord. The fabric dimensions are determined by the diameter of the sand filled form. See FIG. 2 on Page 3.

Step 3. Gather up one end of the fabric covering and place the sand form inside and then gather up the other end and secure. See FIG. 3 on Page 3.

Step 4. Attach top embellishment or ornament with hot glue, thread or other materials. See FIG. 4 on Page 3.

1. I claim that The Decorative Doorstop will function as a very artistic and decorative object that will keep previously opened doors from closing. The unusual and special feature of this doorstop that differentiate it from other doorstops is it's unique and decorative design and construction.

2. I claim that the doorstop is artistic enough in nature to be used as a piece of stand alone decorative art work.
